(19) United States
(12) Patent Application Publication
(10) Pub. No.: US 2026/0358666 A1
(43) Pub. Date: Nov. 12, 2026

(54) DISPLAY PANEL AND DISPLAY DEVICE

(71) Applicant: Xiamen Tianma Micro-Electronics Co., Ltd., Xiamen (CN)

(72) Inventors: Yanlin HE, Xiamen (CN); Ankai LING, Xiamen (CN); Baoling CHEN, Xiamen (CN); Boping SHEN, Xiamen (CN); Shasha NIU, Xiamen (CN); Qiongqin MAO, Xiamen (CN)

(21) Appl. No.: 19/426,677

(22) Filed: Dec. 19, 2025

(30) Foreign Application Priority Data
May 9, 2025 (CN) 202510599746.7

(51) Int. Cl. G02F 1/1362; G02F 1/1333; G02F 1/1368

(52) U.S. Cl. CPC G02F 1/136286; G02F 1/13338; G02F 1/136209; G02F 1/136227; G02F 1/1368; G02F 2201/122; G02F 2201/123

(57) ABSTRACT

The present disclosure provides a display panel and a display device. The display panel includes a substrate; a touch-control wiring, electrically connected to a common electrode through a bridge; and a plurality of data lines and a plurality of scan lines. A pixel unit includes a thin-film transistor and a pixel electrode; the pixel electrode includes a plurality of strip branches; the plurality of strip branches include a first-type strip branch and a second-type strip branch; the first-type strip branch is adjacent to a bridge hole and/or a drain-electrode hole; at the first end, a length of a projection of the first-type strip branch on the substrate along a first direction is less than a length of a projection of the second-type strip branch on the substrate along the first direction; and the first direction is an extension direction of the plurality of strip branches.

### CROSS-REFERENCE TO RELATED APPLICATION

The present disclosure claims the priority of Chinese Patent Application No. 202510599746.7, filed on May 9, 2025, the content of which is incorporated herein by reference in its entirety.

### TECHNICAL FIELD

The present disclosure generally relates to the field of display technology and, more particularly, relates to a display panel and a display device.

### BACKGROUND

A liquid crystal display panel includes an array substrate, a color filter substrate and a liquid crystal layer between the array substrate and the color filter substrate. The array substrate includes thin-film transistors, and pixel electrodes and common electrodes which are above the thin-film transistors. The thin-film transistor includes a gate electrode, a source electrode, a drain electrode, and an active layer. The drain electrode and the pixel electrode are separated by a passivation insulating layer; the drain electrode and the pixel electrode are connected through a via in the passivation insulating layer; and such via is called a drain-electrode hole. In addition, in certain products with touch-control functions, bridge holes may be also configured to connect touch-control wirings to the common electrodes.

In the display field, to reduce the power consumption of the display panel and improve the panel transmittance, methods including reducing the width of the black matrix and the spacing between the pixel electrodes may be used. However, if above extreme reduction methods are used, the pixel electrodes may have short circuit risk with adjacent pixel electrodes at corresponding drain-electrode holes; moreover, the pixel electrodes may also have short circuit risk with corresponding bridge wirings.

### SUMMARY

One aspect of the present disclosure provides a display panel. The display panel includes a substrate; a touch-control wiring, where the touch-control wiring is electrically connected to a common electrode through a bridge, and the bridge includes a bridge hole and a bridge wiring; and a plurality of data lines and a plurality of scan lines. The plurality of data lines and the plurality of scan lines are cross-arranged to form a plurality of pixel units arranged in an array; a pixel unit of the plurality of pixel units includes a thin-film transistor and a pixel electrode; an end of the pixel electrode away from the thin-film transistor is a first end, and an end of the pixel electrode adjacent to the thin-film transistor is a second end; the thin-film transistor includes a drain electrode; the drain electrode is electrically connected to the pixel electrode through a drain-electrode hole; the pixel electrode includes a plurality of strip branches; the plurality of strip branches include a first-type strip branch and a second-type strip branch; the first-type strip branch is adjacent to the bridge hole and/or the drain-electrode hole; and at the first end, a length of a projection of the first-type strip branch on the substrate along a first direction is less than a length of a projection of the second-type strip branch on the substrate along the first direction, where the first direction is an extension direction of the plurality of strip branches.

Another aspect of the present disclosure provides a display device including a display panel. The display panel includes a substrate; a touch-control wiring, where the touch- control wiring is electrically connected to a common electrode through a bridge, and the bridge includes a bridge hole and a bridge wiring; and a plurality of data lines and a plurality of scan lines. The plurality of data lines and the plurality of scan lines are cross-arranged to form a plurality of pixel units arranged in an array; a pixel unit of the plurality of pixel units includes a thin-film transistor and a pixel electrode; an end of the pixel electrode away from the thin-film transistor is a first end, and an end of the pixel electrode adjacent to the thin-film transistor is a second end; the thin-film transistor includes a drain electrode; the drain electrode is electrically connected to the pixel electrode through a drain-electrode hole; the pixel electrode includes a plurality of strip branches; the plurality of strip branches include a first-type strip branch and a second-type strip branch; the first-type strip branch is adjacent to the bridge hole and/or the drain-electrode hole; and at the first end, a length of a projection of the first-type strip branch on the substrate along a first direction is less than a length of a projection of the second-type strip branch on the substrate along the first direction, where the first direction is an extension direction of the plurality of strip branches.

Other aspects of the present disclosure may be understood by those skilled in the art in light of the description, the claims, and the drawings of the present disclosure.

### BRIEF DESCRIPTION OF THE DRAWINGS

In order to clearly explain embodiments of the present disclosure or the technical solutions in the existing technology, the drawings required for describing embodiments or the existing technology are briefly introduced hereinafter. Obviously, the drawings in the following description are merely embodiments of the present disclosure. Other drawings may also be obtained by those skilled in the art without any creative work according to provided drawings.

FIG. 1 illustrates a structural schematic of an array substrate according to various embodiments of the present disclosure.

FIG. 2 illustrates a cross-sectional view along an A-A’ line in FIG. 1.

FIG. 3 illustrates another structural schematic of an array substrate according to various embodiments of the present disclosure.

FIG. 4 illustrates another structural schematic of an array substrate according to various embodiments of the present disclosure.

FIG. 5 illustrates another structural schematic of an array substrate according to various embodiments of the present disclosure.

FIG. 6 illustrates another structural schematic of an array substrate according to various embodiments of the present disclosure.

FIG. 7 illustrates another structural schematic of an array substrate according to various embodiments of the present disclosure.

FIG. 8 illustrates another structural schematic of an array substrate according to various embodiments of the present disclosure.

FIG. 9 illustrates another structural schematic of an array substrate according to various embodiments of the present disclosure.

FIG. 10 illustrates another structural schematic of an array substrate according to various embodiments of the present disclosure.

FIG. 11 illustrates another structural schematic of an array substrate according to various embodiments of the present disclosure.

FIG. 12 illustrates another structural schematic of an array substrate according to various embodiments of the present disclosure.

FIG. 13 illustrates another structural schematic of an array substrate according to various embodiments of the present disclosure.

FIG. 14 illustrates another structural schematic of an array substrate according to various embodiments of the present disclosure.

FIG. 15 illustrates another structural schematic of an array substrate according to various embodiments of the present disclosure.

FIG. 16 illustrates another structural schematic of an array substrate according to various embodiments of the present disclosure.

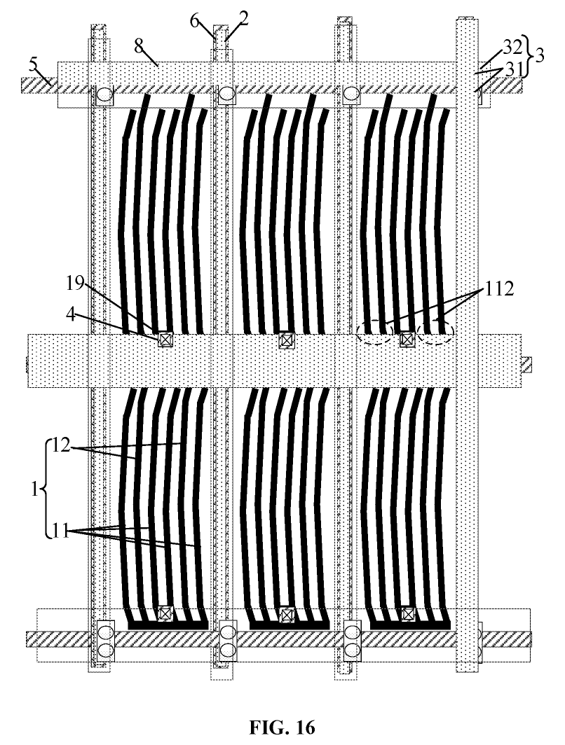

FIG. 17 illustrates a cross-sectional structural view of a display panel according to various embodiments of the present disclosure.

FIG. 18 illustrates a structural schematic of a display device according to various embodiments of the present disclosure.

### DETAILED DESCRIPTION

The technical solutions in embodiments of the present disclosure are clearly described by combining accompanying drawings and embodiments of the present disclosure. Obviously, described embodiments may be only a part, not all, of embodiments of the present disclosure. Based on embodiments in the present disclosure, all other embodiments obtained by those skilled in the field without creative work may be within the scope of protection of the present disclosure.

In the present disclosure, each embodiment is described in a progressive manner. Each embodiment may focus on the differences from other embodiments. Same or similar parts between embodiments may be referred to each other. The device disclosed in embodiments may correspond to methods disclosed in embodiments. The description of the device disclosed in embodiments may be relatively simple, which may refer to methods disclosed in embodiments.

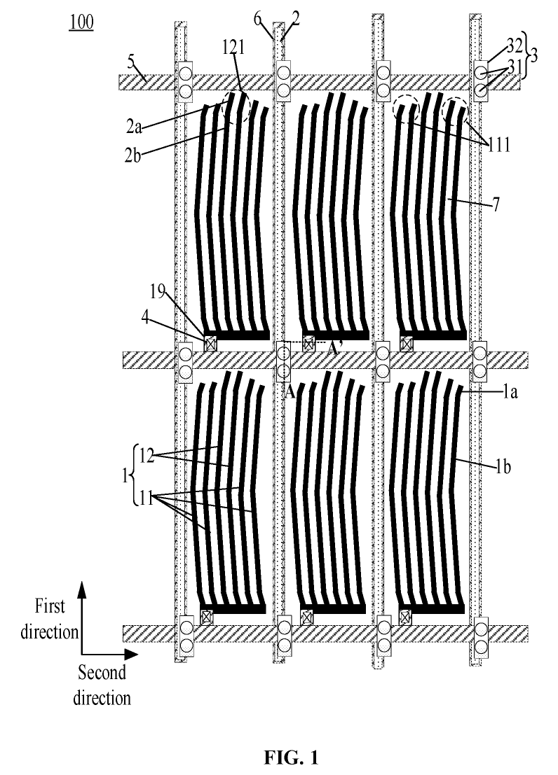

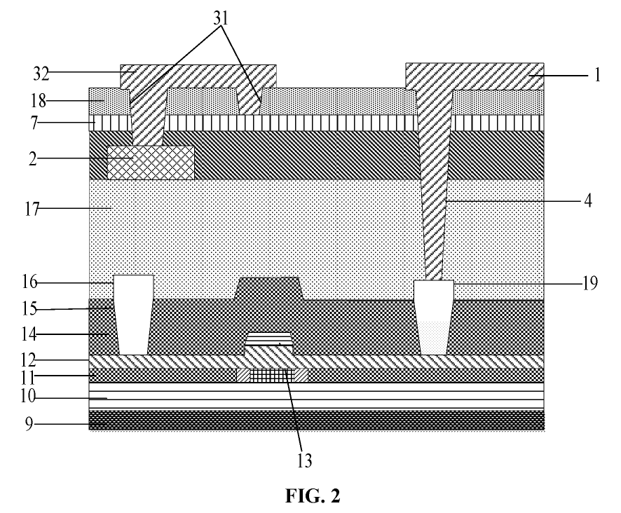

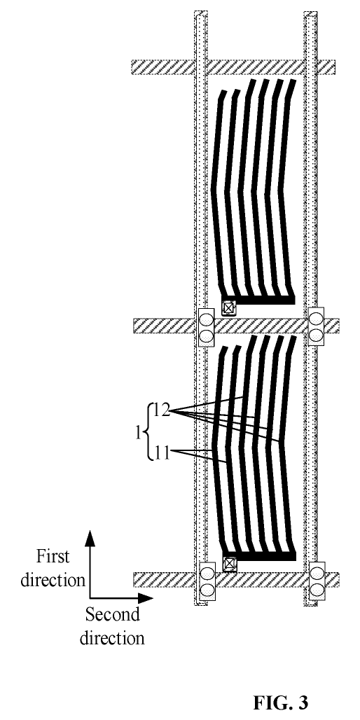

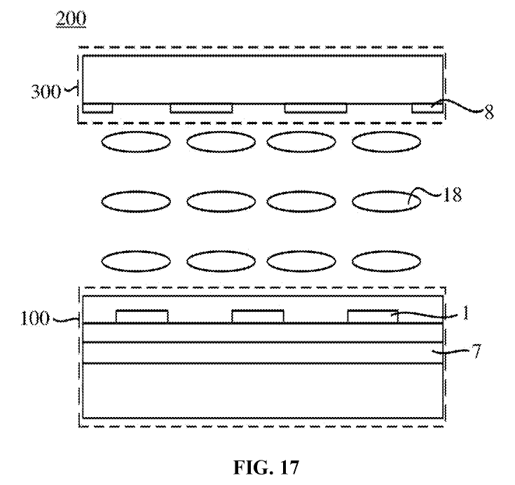

FIG. 1 illustrates a structural schematic of an array substrate according to various embodiments of the present disclosure; FIG. 2 illustrates a cross-sectional view along an A-A’ line in FIG. 1; FIG. 3 illustrates another structural schematic of an array substrate according to various embodiments of the present disclosure; and FIG. 17 illustrates a cross-sectional structural view of a display panel according to various embodiments of the present disclosure. The present disclosure provides a display panel 200. The display panel 200 may include a substrate 9; a plurality of touch-control wirings 2, where the touch-control wiring 2 may be electrically connected to a common electrode 7 through a bridge 3, and the bridge 3 may include a bridge hole 31 and a bridge wiring 32; and further include a plurality of data lines 6 and a plurality of scan lines 5 which are cross-arranged to form a plurality of pixel units arranged in an array. The pixel unit may include a thin-film transistor and a pixel electrode 1. The end of the pixel electrode away from the thin-film transistor may be the first end, and the end of the pixel electrode adjacent to the thin-film transistor may be the second end. The thin-film transistor may include a drain electrode 19 which may be electrically connected to the pixel electrode 1 through a drain-electrode hole 4. The pixel electrode 1 may include a plurality of strip branches. The plurality of strip branches may include a first-type strip branch 11 and a second-type strip branch 12. The first-type strip branch 11 may be adjacent to the bridge hole 31 and/or the drain-electrode hole 4. At the first end, the length of the projection of the first-type strip branch 11 on the substrate along the first direction may be less than the length of the projection of the second-type strip branch 12 on the substrate along the first direction, and the first direction may be the extension direction of the strip branch.

For example, the display panel 200 may include the substrate 9. Optionally, the substrate 9 may be made of glass or plastic. The plurality of data lines 6 and the plurality of scan lines 5 may be arranged on the substrate 9. The data lines 6 and the scan lines 5 may be cross-arranged to form the plurality of pixel units arranged in an array. The pixel unit may include the thin-film transistor and the pixel electrode 1. The end of the pixel electrode away from the thin-film transistor may be the first end, and the end of the pixel electrode adjacent to the thin-film transistor may be the second end. The thin-film transistor may include a source electrode 16, the drain electrode 19 and a gate electrode 13. The pixel electrode 1 may be electrically connected to the drain electrode 19 through the drain-electrode hole 4. When displaying an image, an image signal voltage may be inputted to the pixel electrode 1 through the drain electrode 19, such that an electric field may be formed between the array substrate 100 (that is, substrate) and the color filter substrate 300 arranged opposite to the array substrate 100 to deflect the liquid crystal molecules 18 in the liquid crystal layer, thereby displaying the image. The display panel 100 may further include the touch-control wiring 2. The touch-control wiring 2 may be electrically connected to the common electrode 7 through the bridge 3 that passes through a passivation layer 18. The bridge 3 may include the bridge hole 31 and the bridge wiring 32. Optionally, to reduce costs, the bridge wiring 32 may be formed in a same pixel electrode layer (film layer) and made with a same material as the pixel electrode 1. The pixel electrode 1 may include the plurality of strip branches which may include the first-type strip branch 11 and the second-type strip branch 12.

Optionally, as shown in FIG. 3, when the first-type strip branch 11 is also adjacent to one side of the drain-electrode hole 4 of the pixel electrode 1 in same column and adjacent row, that is, for the pixel electrode 1 in FIG. 3, when the first-type strip branch 11 is located on the left side of the pixel electrode 1, at the first end of the pixel electrode, the length of the projection of the first-type strip branch 11 on the substrate along the first direction may be less than the length of the projection of the second-type strip branch 12 on the substrate along the first direction. That is, the length of the projection of the first-type strip branch 11 on the substrate, adjacent to a side of the drain-electrode hole 4 of the pixel electrode 1, may be also less than the length of the projection of the second-type strip branch 12 on the substrate along the first direction. In such way, by optimizing the pixel design and increasing the spacing between the first-type strip branch 11 and the pixel electrode 1 at the position of the drain-electrode hole 4 of adjacent row, the problem of short circuit caused by small spacing between the first-type strip branch 11 and the pixel electrode 1 at the position of the drain-electrode hole 4 of adjacent row, which is due to extreme reduction of the spacing between two adjacent rows of pixel electrodes 1, may be effectively solved.

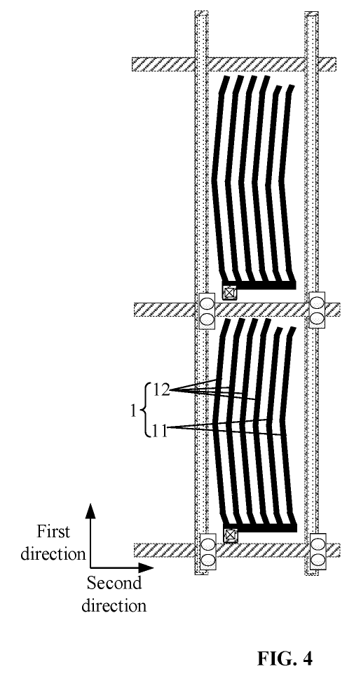

Optionally, as shown in FIG. 4, when the first-type strip branch 11 is located on the side of the pixel electrode 1 adjacent to the bridge hole 31, that is, for the pixel electrode 1 in FIG. 4, when the first-type strip branch 11 is located on the right side of the pixel electrode 1, at the first end of the pixel electrode, the length of the projection of the first-type strip branch 11 on the substrate along the first direction may be less than the length of the projection of the second-type strip branch 12 on the substrate along the first direction. That is, the length of the projection of the first-type strip branch 11 on the substrate, at the side of the pixel electrode 1 adjacent to the bridge hole 31, along the first direction may be less than the length of the projection of the second-type strip branch 12 on the substrate, at the side of the pixel electrode 1 adjacent to the bridge hole 31, along the first direction. In such way, by optimizing the pixel design and increasing the spacing between the first-type strip branch 11 and the bridge wiring 32 at the position of the bridge hole 31, the problem of short circuit caused by small spacing between the first-type strip branch 11 and the bridge wiring 32 at the position of the bridge hole 31, which is due to extreme reduction of the spacing between two adjacent rows of pixel electrodes 1, may be effectively solved.

Optionally, as shown in FIG. 1, the first-type strip branches 11 may be on the side of the pixel electrode 1 adjacent to the bridge hole 31, and the first-type strip branched 11 may be also adjacent to the side of the drain-electrode hole 4 of the pixel electrode 1 in same column and adjacent row; that is, for the pixel electrode 1 in FIG. 1 , the first-type strip branches 11 may be on the two opposite sides of the pixel electrode 1 along the second direction. At the first end of the pixel electrode, the length of the projection of the first-type strip branch 11 on the substrate along the first direction may be less than the length of the projection of the second-type strip branch 12 on the substrate along the first direction. That is, the length of the projection of the first-type strip branch 11 on the substrate, which is on the side of the pixel electrode 1 and adjacent to the bridge hole 31, along the first direction may be less than the length of the projection of the second-type strip branch 12 on the substrate, which is on the side of the pixel electrode 1 and adjacent to the bridge hole 31, along the first direction; and the length of the first-type strip branch 11, which is on the side adjacent to the drain-electrode hole 4 of the pixel electrode 1, along the first direction may be also less than the length of the projection of the second-type strip branch 12 on the substrate, which is on the side adjacent to the drain-electrode hole 4 of the pixel electrode 1, along the first direction. That is, at the first end of the pixel electrode 1, the distance between the second-type strip branch 12 and adjacent pixel electrode in same column may be less than the distance between the first-type strip branch 11 and adjacent pixel electrode in same column. Therefore, through such pixel optimization design, the spacing between the first-type strip branch 11 and the bridge wiring 32 at the position of the bridge hole 31 may be increased, and the spacing between the first-type strip branch 11 and the pixel electrode 1 at the position of the drain-electrode hole 4 at adjacent row may be increased, which may effectively reduce the short circuit problem caused by the short spacing between the first-type strip branch 11 and the bridge wiring 32 at the position of the bridge hole 31 and the short circuit problem caused by the short spacing between the first-type strip branch 11 and the pixel electrode 1 at the drain-electrode hole 4 at adjacent row, which are due to extreme reduction of the spacing between two adjacent rows of pixel electrodes 1.

Furthermore, referring to FIGS. 1, 3 and 4, in the display panel 200 provided by the present disclosure, the distance between the first-type strip branch 11 and the bridge hole 31 and/or the distance between the first-type strip branch 11 and the drain-electrode hole 4 may be ≤ 2.6μm.

Optionally, as shown in FIG. 1 , when the distance between the bridge hole 31 and the strip branch of the pixel electrode 1 adjacent to the bridge hole 31 is ≤ 2.6μm, and when the distance between the drain-electrode hole 4 and the strip branch of the pixel electrode 1 adjacent to the drain-electrode hole 4 is ≤ 2.6μm, the strip branch of the pixel electrode 1 adjacent to the bridge hole 31 and the strip branch of the pixel electrode 1 adjacent to the drain-electrode hole 4 may be both first-type strip branches 11.

Optionally, as shown in FIG. 3, when the distance between the drain-electrode hole 4 and the strip branch of the pixel electrode 1 adjacent to the drain-electrode hole 4 is ≤ 2.6μm, but the distance between the bridge hole 31 and the strip branch of the pixel electrode 1 adjacent to the bridge hole 31 is > 2.6μm, the strip branches of the pixel electrode 1 adjacent to the drain-electrode hole 4 may be both first-type strip branches 11.

Optionally, as shown in FIG. 4, when the distance between the bridge hole 31 and the strip branch of the pixel electrode 1 adjacent to the bridge hole 31 is ≤ 2.6μm, but the distance between the drain-electrode hole 4 and the strip branch of the pixel electrode 1 adjacent to the drain-electrode hole 4 is > 2.6μm, the strip branch of the pixel electrode 1 adjacent to the bridge hole 31 may be the first-type strip branch 11.

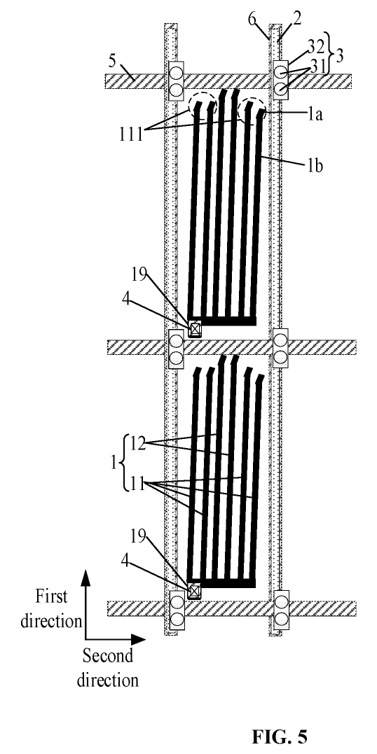

Furthermore, referring to FIGS. 1 and 5, in the display panel 200 provided by the present disclosure, the first-type strip branch 11 may include the first bent portion 1a and the second bent portion 1b; the first bent portion 1a may intersect the second bent portion 1b; and the intersection of the first bent portion 1a and the second bent portion 1b may be the first corner 111.

For example, in the pixel electrode 1, the first-type strip branch 11 may include the first bent portion 1a and the second bent portion 1b; the first bent portion 1a and the second bent portion 1b may have different extension directions along the first direction; the first bent portion 1a and the second bent portion 1b may intersect at the first corner 111; and the first corner 111 may be at an end of the pixel electrode 1 away from the thin-film transistor. In such way, by configuring the first corner 111 at the end portion (i.e. end ) of the first-type strip branch 11 away from the thin-film transistor, the torsional force of the pixel electrode 1 on the liquid crystal molecules may be effectively increased, and the liquid crystal molecules at the first corner 111 may be quickly deflected and restored to the arrangement state of the equilibrium state. Therefore, it may effectively reduce the problem that the liquid crystal molecules may have disordered domains due to the action of external force, which may result in that the brightness of the region of the display panel 200 affected by the external force may be inconsistent with the brightness of the region of the display panel 200 not affected by the external force, and scratches may appear in the display panel 200. In the present disclosure, the length of the first-type strip branch 11 along the first direction may be reduced, the distance between the first-type strip branch 11 and the bridge 3 may be increased, such that the distance between the first-type strip branch 11 and the bridge 3 may be within a reasonable range, for example, the minimum distance recognized by a machine platform and a mask. Meanwhile, the first corner 111 may be configured at the end portion of the first-type strip branch 11 away from the thin-film transistor. The present disclosure may not only ensure that the pixel electrode 1 has high transmittance performance and avoids the risk of short circuit between the pixel electrode 1 and the bridge 3 but also ensure that the display panel 200 may not have scratches under the action of external force.

It should be noted that the pixel electrode 1 may be a single domain structure, a dual domain structure, or other multi-domain structures, which may not be limited in the present disclosure.

Furthermore, referring to FIG. 1, in the display panel 200 provided by the present disclosure, the second-type strip branch 12 may include the third bent portion 2a and the fourth bent portion 2b. The third-bent portions 2a may intersect the fourth bent portion 2b. The intersection of the third-bent portions 2a and the fourth bent portion 2b may be the second corner 121. The angle of the second corner 121 may be greater than the angle of the first corner 111.

Exemplarily, FIG. 1 illustrates that in the pixel electrode 1, the second-type strip branch 12 may include the third bent portion 2a and the fourth bent portion 2b; the third bent portion 2a and the fourth bent portion 2b may have different extension directions along the first direction; the third bent portion 2a and the fourth bent portion 2b may intersect at the second corner 121; and the angle of the second corner 121 may be greater than the angle of the first corner 111, that is, the angle between the third bent portion 2a and the fourth bent portion 2b in the second-type strip branch 12 may be greater than the angle between the first bent portion 1a and the second bent portion 1b in the first-type strip branch 11. In other words, compared with the first-type strip branch 11, the third bent portion 2a and the fourth bent portion 2b in the second-type strip branch 12 may be closer to a straight line after intersection, which may be because the second-type strip branch 12 is not adjacent to the bridge 3 or the drain-electrode hole 4 of adjacent pixel electrode 1, and the distance between the second-type strip branch 12 and the pixel electrode 1 in same column and adjacent row may be less than the distance between the first-type strip branch 11 and the pixel electrode 1 in same column and adjacent row. In such way, it may not only improve the transmittance of the pixel electrode 1 but also avoid the black domain problem generated by the pixel electrode 1 due to small corner angle. In multi-domain pixel units, the electric field at the pixel corners may be not ideally parallel. Therefore, when the electric field formed by the common electrode and the pixel electrode drives the liquid crystal molecules to deflect, the deflection direction of the liquid crystal molecules cannot reach ideal direction, which may result in the light deflection of the liquid crystal molecules to be deviated, such that the transmittance in corner regions may be relatively low. That is, black domains may occur at the corner region to affect light transmittance.

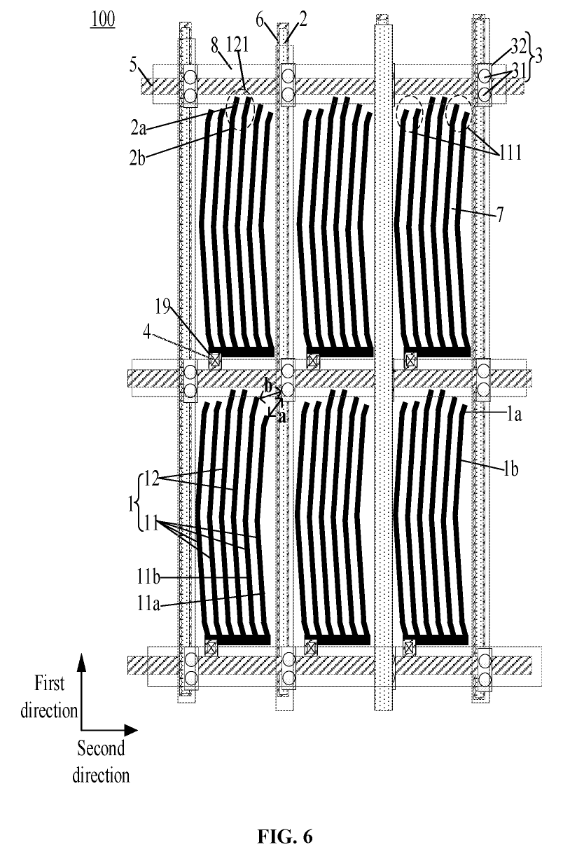

Furthermore, FIG. 6 illustrates another structural schematic of an array substrate according to various embodiments of the present disclosure. In the display panel 200 provided by the present disclosure, a light-blocking layer 8 may be included. Along the direction perpendicular to the display panel 200, the second-type strip branch 12 may be at least partially overlapped with the light-blocking layer 8.

For example, the display panel 200 may include the light-blocking layer 8; the light-blocking layer 8 may be configured on the side of the color filter substrate 300 adjacent to the array substrate 100; and along the direction perpendicular to the display panel 200, the light-blocking layer 8 may be at least partially overlapped with the second-type strip branches 12. In the present disclosure, entire length of the second-type strip branch 12 may be extended along the first direction, and the end portion of the second-type strip branch 12 may extend to the vertical projection range of the light-blocking layer 8 on the array substrate 100, such that the electric field disorder area at the edge of the end portion of the second-type strip branch 12 may be covered by the light-blocking layer 8. The present disclosure may effectively avoid the electric field disorder at the edge of the pixel electrode 1 and improve the transmittance of the display panel 200. Optionally, in the display panel 200 provided by the present disclosure, along the direction perpendicular to the display panel 200, the first-type strip branch 11 may be at least partially overlapped with the light-blocking layer 8. That is, the end portion of the first-type strip branch 11 may extend to the vertical projection range of the light-blocking layer 8 on the array substrate 100, such that the electric field disorder area at the end edge of the first-type strip branch 11 may be covered by the light-blocking layer 8, which may effectively avoid the electric field disorder at the edge of the pixel electrode 1 and improve the transmittance of the display panel 200.

Optionally, in the display panel 200 provided by the present disclosure, along the direction perpendicular to the display panel 200, the first-type strip branch 11 may be at least partially overlapped with the light-blocking layer 8. That is, the end portion of the first-type strip branch 11 may extend to the vertical projection range of the light-blocking layer 8 on the array substrate 100, such that the electric field disorder area at the edge of the end portion of the first- type strip branch 11 may be covered by the light-blocking layer 8, which may effectively avoid the electric field disorder at the edge of the pixel electrode 1 and improve the transmittance of the display panel 200.

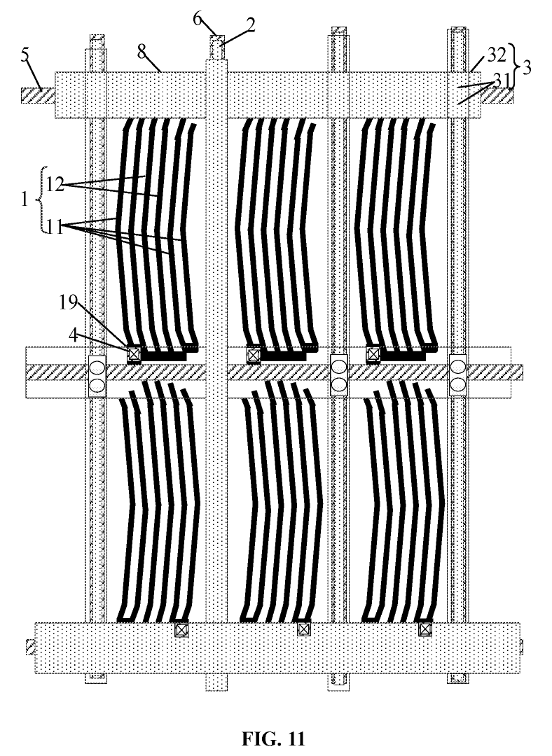

Furthermore, FIGS. 11-13 respectively illustrate structural schematics of an array substrate according to various embodiments of the present disclosure. In the display panel 200 provided by the present disclosure, in two adjacent rows and/or two adjacent columns, the pixel electrodes 1 may be arranged in a zigzag pattern.

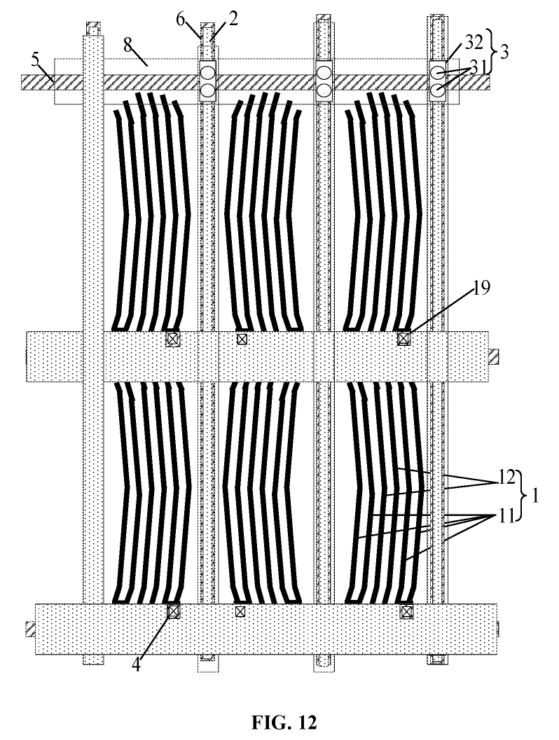

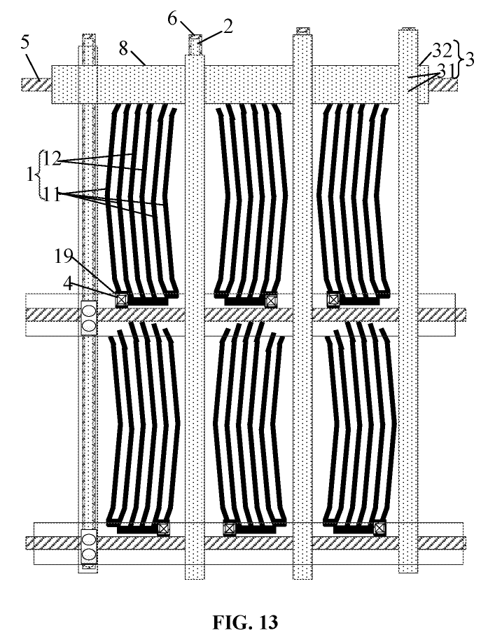

For example, in two adjacent rows, the pixel electrodes 1 of the display panel 200 may be arranged in a zigzag pattern above the passivation layer 18. As shown in FIG. 11, the tilting direction of the pixel electrode 1 and the tilting direction of the pixel electrode 1 in adjacent row and same column may be opposite along the first direction; or as shown in FIG. 12, the tilting direction of the pixel electrode 1 and the tilting direction of the pixel electrode 1 in adjacent column and same row may be opposite along the first direction; or as shown in FIG. 13, the tilting direction of the pixel electrode 1 and the tilting direction of the pixel electrode 1 in adjacent row may be opposite along the first direction, and the tilting direction of the pixel electrode 1 and the tilting direction of the pixel electrode 1 in adjacent column may be also opposite along the first direction. In such way, by alternately arranging the zigzagged pixel electrodes 1, a multi-directional electric field may be formed, which may force the liquid crystal molecules to deflect uniformly in multiple directions, thereby effectively improving the dispersion characteristics of the display panel 200. Furthermore, the wide viewing angle characteristics of the display panel 200 may be improved, and the brightness attenuation and color distortion when the display panel is viewed from sides may be reduced.

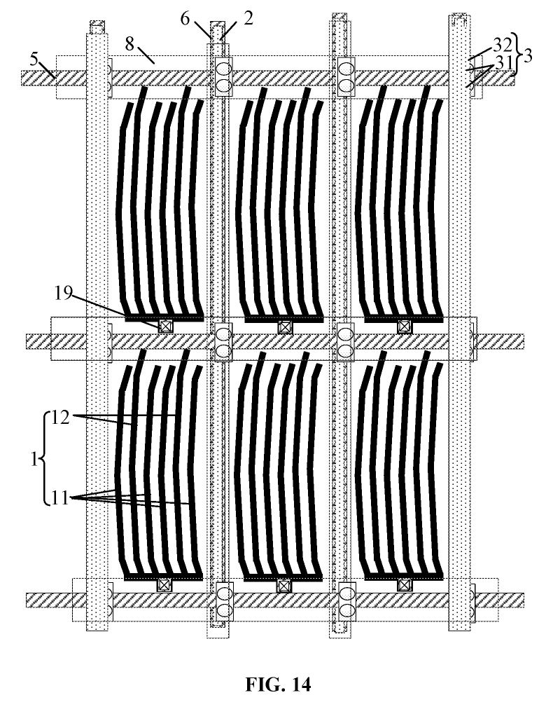

Furthermore, FIG. 14 illustrates another structural schematic of an array substrate according to various embodiments of the present disclosure. Referring to FIGS. 1 and 14, in the display panel 200 provided by the present disclosure, in a pixel unit, the thin-film transistor may be at an end portion or a middle position of the pixel electrode 1.

For example, as shown in FIG. 1, along the plane perpendicular to the display panel 200, the thin-film transistor may be at the left end portion of the pixel electrode 1. Optionally, the thin-film transistor may also be at the right end portion of the pixel electrode 1 (not shown in the present disclosure). In such way, arranging the thin-film transistors at two end portions of the pixel electrode may reduce the interference of the thin-film transistor area on the electric field of the pixel area and reduce the coupling effect of the parasitic capacitance on the driving of the liquid crystals. Furthermore, as shown in FIG. 14, the thin-film transistor may also be in the middle position of the end portion of the pixel electrode 1. In such way, the electric field direction of the pixel electrode 1 may be symmetrical, uneven driving of the liquid crystal molecules caused by the asymmetry of the pixel electrode 1 may be reduced, the signal transmission path may be shortened, the resistance-capacitance delay may be reduced, and the pixel charging speed may be improved. In one embodiment, in the pixel unit, the thin-film transistor may be at a side or a middle position of the second end of the pixel electrode along a second direction, where the first direction may be perpendicular to the second direction.

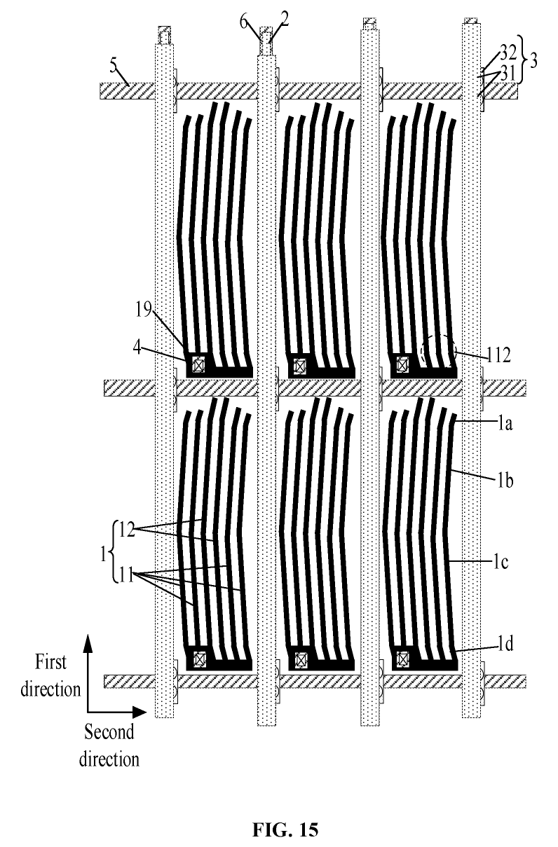

Furthermore, FIG. 15 illustrates another structural schematic of an array substrate according to various embodiments of the present disclosure. In the display panel 200 provided by the present disclosure, a part of the strip branches of the pixel electrode 1 may extend to be coplanar with the end of the thin-film transistor away from the drain-electrode hole 4. In one embodiment, a projection of a part of the plurality of strip branches of the pixel electrode on the substrate along the second direction may be overlapped with a projection of the thin-film transistor on the substrate along the second direction.

For example, as shown in FIG. 15, in the display panel 200 provided by the present disclosure, a part of the strip branches of the pixel electrode 1 may extend to be coplanar with the lower end of the thin-film transistor, that is, one end adjacent to the scan line 5. Optionally, at the area which the thin-film transistor is avoided, the length of the strip branch of the pixel electrode 1 may be extended to be coplanar with the lower end of the thin-film transistor, and the projection of a part of the strip branches on the substrate along the second direction may be overlapped with the projection of the thin-film transistor on the substrate along the second direction. In such way, by extending the length of a part of the strip branches, the aperture ratio of the pixel electrode on the display panel 200 may be increased, and the transmittance may be effectively improved.

Furthermore, referring to FIG. 15, in the display panel 200 provided by the present disclosure, at least a part of the strip branches may include the fifth bent portion 1c and the sixth bent portion 1d; the fifth bent portion 1c may intersect the sixth bent portion 1d ; the intersection of the fifth bent portion 1c and the sixth bent portion 1d may be the third corner 112; and the projection of the third corner 112 along the second direction may be overlapped with the projection of the thin-film transistor along the second direction.

In one embodiment, at least a part of the plurality of strip branches may include a first wiring and a second wiring; the first wiring and the second wiring may have an intersection; and a projection of the intersection on the substrate along a second direction may be overlapped with a projection of the thin-film transistor on the substrate along the second direction, where the first direction may be perpendicular to the second direction.

For example, as shown in FIG. 15, in the pixel electrode 1, at least a part of the strip branches may include the fifth bent portion 1c and the sixth bent portion 1d; the fifth bent portion 1c and the sixth bent portion 1d may extend in different directions along the first direction; the fifth bent portion 1c and the sixth bent portion 1d may intersect at the third corner 112; and the projection of the third corner 112 along the second direction may be overlapped with the projection of the thin-film transistor along the second direction. In such way, by configuring the third corner 112 at one end of the pixel electrode 1 adjacent to the thin-film transistor, the torsional force of the pixel electrode 1 on the liquid crystal molecules may be effectively enhanced, and the liquid crystal molecules at the third corner 112 may be quickly deflected and restored to the arrangement state of the equilibrium state. Therefore, it may effectively reduce the problem that the liquid crystal molecules may have disordered domains due to the action of external force, which may result in that the brightness of the region of the display panel 200 affected by the external force may be inconsistent with the brightness of the region of the display panel 200 not affected by the external force, and scratches may appear in the display panel 200.

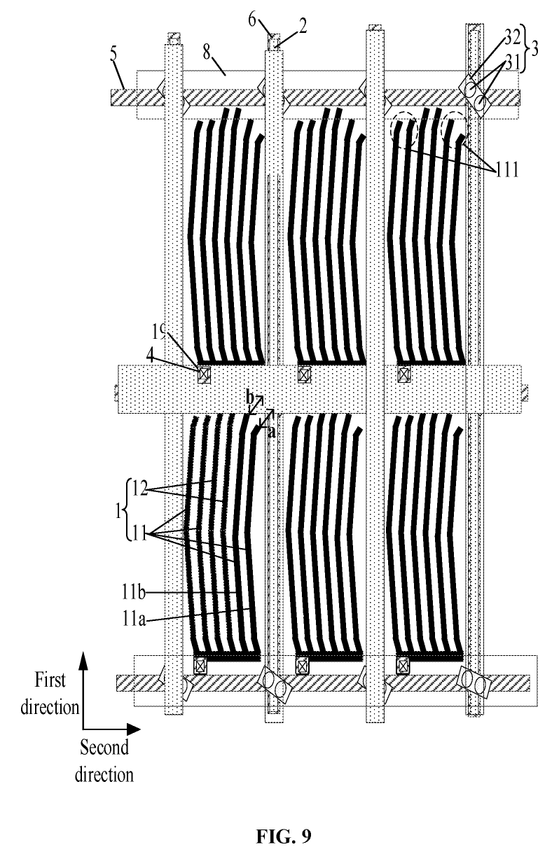

Furthermore, FIGS. 6-9 respectively illustrate structural schematics of an array substrate according to various embodiments of the present disclosure. In the display panel 200 provided by the present disclosure, the bridge hole 31 may be any one of a vertical hole, an oblique hole, and a horizontal hole.

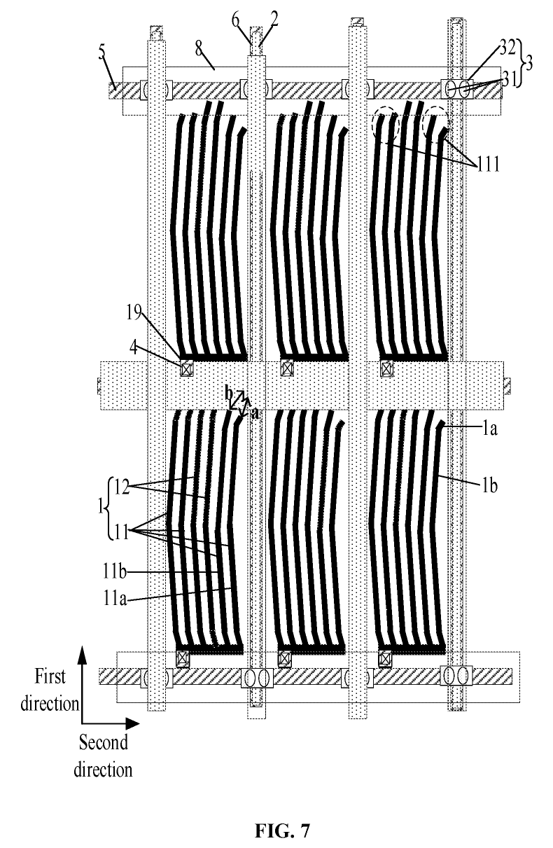

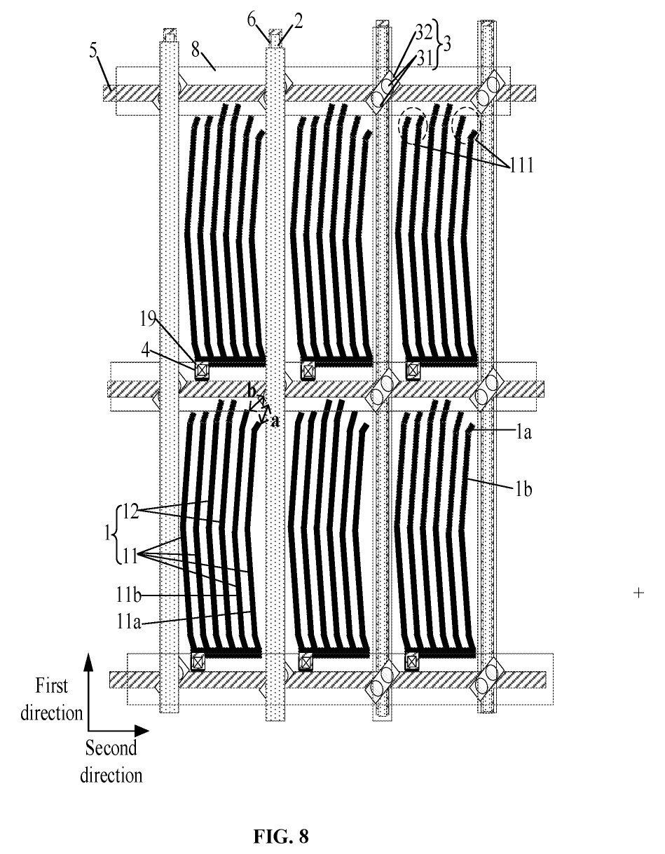

For example, referring to FIGS. 6-9, the bridge hole 31 shown in FIG. 6 may be a vertical hole, and the projection of the bridge hole 31 on the array substrate 100 may be in parallel with the extension direction of the data line 6; optionally, as shown in FIG. 7, the bridge hole 31 may be a horizontal hole, that is, the projection of the bridge hole 31 on the array substrate 100 may be perpendicular to the extension direction of the data line 6; optionally, as shown in FIGS. 8- 9, the bridge hole 31 may be an oblique hole, that is, the projection of the bridge hole 31 on the array substrate 100 may be at a certain angle to the data line 6, and the angle may be not equal to 90°. Therefore, the length of the first-type strip branch 11 along the first direction when the bridge hole 31 is the horizontal hole or the oblique hole may be greater than the length of the first-type strip branch 11 along the first direction when the bridge hole 31 is the vertical hole, such that the opening area of the pixel electrode 1 may be increased, and the transmittance of the display panel 200 may be increased.

Furthermore, referring to FIGS. 6-9, in the display panel 200 provided by the present disclosure, the length of the first-type strip branch 11 adjacent to the bridge hole 31 along the first direction may be less than the length of the first-type strip branch 11 away from the bridge hole 31 along the first direction.

For example, as shown in FIGS. 6-9, the first-type strip branch 11 may include first-type sub-strip-branches 11a and 11b, where the first-type sub-strip-branch 11a may be adjacent to the bridge hole 31, and the first-type sub-strip-branch 11b may be away from the bridge hole 31. The bridge hole 31 mentioned herein may be the bridge hole 31 at the thin-film transistor adjacent to the first-type strip branch 11 and away from the pixel electrode 1, that is, the bridge hole 31 at the upper right corner of the pixel electrode 1 shown in FIGS. 6-9. The distance between the first-type sub-strip-branch 11a and the bridge hole 31 may be different from the distance between the first-type sub-strip-branch 11b and the bridge hole 31. In order to maximize the transmittance of the pixel electrode 1, in the present disclosure, the projection lengths of the first-type sub-strip-branch 11a and the first-type sub-strip-branch 11b along the first direction may be desirably configured according to the distance between the first-type sub- strip-branch 11a/the first-type sub-strip-branch 11b and the bridge hole 31. Optionally, the projection length of the first-type sub-strip-branch 11a along the first direction may be configured to be less than the projection length of the first-type sub-strip-branch 11b along the first direction. As shown in FIGS. 6-9, the distance between the first-type sub-strip-branch 11a and the bridge hole 31 may be relatively short, and the distance between the second-type sub-strip-branch 11b and the bridge hole 31 may be relatively long, such that the increase in the distance between the first-type sub-strip-branch 11a and the bridge hole 31 may be greater than the increase in the distance between the second-type sub-strip-branch 11b and the bridge hole 31; that is, the reduction degree of the first-type sub-strip-branch 11a may be greater than the reduction degree of the first-type sub-strip-branch 11b. The shortest distance between the first-type sub-strip-branch 11a and the bridge hole 31 may be a, and the shortest distance between the first-type sub-strip-branch 11b and the bridge hole 31 may be b, which may ensure that a and b are within a reasonable value range, such as within 2.6μm. In such way, when the pixel electrode 1 is patterned, short circuit may not occur due to the short distance between the first-type strip branch 11 and the bridge 3 of the thin-film transistor which is adjacent to the first-type strip branch 11 and away from the pixel electrode 1. Meanwhile, due to the differential design of the projection lengths of the first-type sub-strip-branch 11a and the first-type sub-strip-branch 11b along the first direction, the transmittance of the display panel may be maintained at high level.

Furthermore, referring to FIGS. 6-9, in the display panel 200 provided by the present disclosure, the angle of the first corner 111 adjacent to the bridge hole 31 may be less than the angle of the first corner 111 away from the bridge hole 31. In one embodiment, an angle of the first corner 111 adjacent to the bridge hole 31 which is close to the first end of the pixel electrode, may be less than an angle of the first corner 111 away from the bridge hole 31 which is close to the first end of the pixel electrode.

For example, as shown in FIGS. 6-9, the first-type strip branch 11 may include first-type sub-strip-branches 11a and 11b, where the first-type sub-strip-branch 11a may be adjacent to the bridge hole 31, and the first-type sub-strip-branch 11b may be away from the bridge hole 31. The bridge hole 31 mentioned herein may be the bridge hole 31 at the thin-film transistor adjacent to the first-type strip branch 11 and away from the pixel electrode 1, that is, the bridge hole 31 at the upper right corner of the pixel electrode 1 shown in FIGS. 6-9. The distances between different first-type strip branches 11 and the bridge holes 31 are different, such that the angle of the first corner 111 of each first-type strip branch 11 may be desirably designed according to the distance between each first-type strip branch 11 and the bridge hole 31. Optionally, the angle of the first corner 111 of the first-type sub-strip-branch 11a may be designed to be relatively small, such that the inclination of the first bent portion 1a may be relatively small, and the shortest distance between the bridge hole 31 and the first-type sub-strip-branch 11a adjacent to the bridge hole 31 may be relatively large. Optionally, the angle of the first corner 111 of the first-type sub-strip branch 11b may be designed to be relatively large, such that the inclination of the first bent portion 1a may be relatively large, and the shortest distance between the first-type sub-strip branch 11b and the bridge hole 31 may be relatively large. In such way, the present disclosure may not only reduce the short circuit problem between the pixel electrode 1 and the bridge 3 of the thin-film transistor adjacent to the first-type strip branch 11 and away from the pixel electrode 1 due to the short distance, but also make the pixel electrode 1 less likely to produce black domain because the angle of the first corner 111 of the first-type sub-strip-branch 11b is designed to be relatively large.

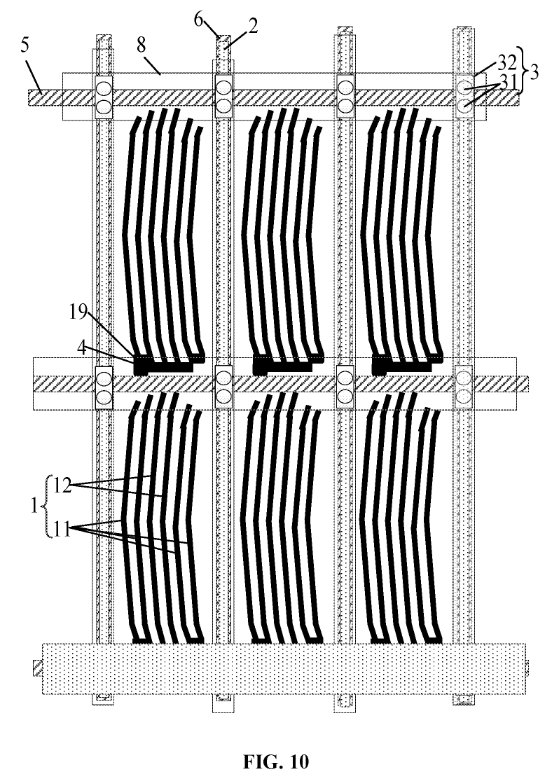

Furthermore, FIG. 10 illustrates another structural schematic of an array substrate according to various embodiments of the present disclosure. In the display panel 200 provided by the present disclosure, the light-blocking layer 8 may be included; the projections of the vertical hole and the light-blocking layer 8 on the substrate may be overlapped with each other; and the projections of two opposite end portions of the first-type strip branch 11 along the first direction and the projections of two opposite end portions of the second-type strip branch 12 along the first direction may be not overlapped with each other along the second direction.

For example, referring to FIG. 10, the projections of the bridge hole 31 and the light-blocking layer 8 on the substrate may be overlapped with each other, and the bridge hole 31 may be closer to the middle between two adjacent columns of pixel electrodes 1. Therefore, the distances between the bridge hole 31 (adjacent to the side of the first-type strip branch 11) and the first-type strip branches 11 of two adjacent rows of pixel electrodes 1 may be relatively small, and the first-type strip branch 11 and the bridge wiring 32 may easily have short-circuit due to small spacing. Therefore, in the present disclosure, an avoidance design may be configured at two opposite end portions of the first-type strip branch 11 along the first direction, and the lengths of two end portions of the first-type strip branch 11 along the first direction may be less than the lengths of two end portions of the second-type strip branch 12 along the first direction. In such way, the projections of two opposite end portions of the first-type strip branch 11 along the first direction and the projections of two opposite end portions of the second-type strip branch 12 along the first direction may be not overlapped with each other along the second direction, which may increase the distances between the bridge hole 31 (adjacent to the side of the first-type strip branch 11) and the first-type strip branches 11 of two adjacent rows of pixel electrodes 1, thereby solving the short circuit problem caused by extremely small spacing between the pixel electrode 1 and the bridge hole 31.

Referring to FIG. 1, in the display panel 200 provided by the present disclosure, the pixel electrode 1 may include a connecting portion 1d, and the ends of the strip branches adjacent to the thin-film transistor may be connected through the connecting portion 1d. Therefore, each strip branch may be ensured to be connected through the connecting portion 1d, such that the pixel electrode 1 may form a stable electric field. When the display panel 200 is powered on, the liquid crystal molecules 18 may be driven to rotate, and the display panel 200 may display pictures.

Furthermore, referring to FIG. 6, in the display panel 200 provided by the present disclosure, the display panel 200 may include the light-blocking layer 8; the ends of the strip branches away from the thin-film transistor may be all not connected by the connecting portion; and along the direction perpendicular to the display panel, the ends of the strip branches away from the thin-film transistor may be at least partially overlapped with the light-blocking layer 8.

For example, as shown in FIG. 6, the ends of the strip branches away from the thin-film transistor may be all not connected by the connecting portion 1d, that is, a completely unclosed structure may be adopted. The electric field generated by the connecting portion 1d along the second direction may be different from the electric field generated by the strip branch along the first direction, which may easily cause the liquid crystal molecules to deflect in a disordered manner under pressure. In the present disclosure, the ends of the strip branches away from the thin-film transistor may be configured to a completely unclosed state, thereby solving the deflection disorder problem of the liquid crystal molecules under pressure. Furthermore, the end of the strip branch away from the thin-film transistor may easily produce black domain. In the present disclosure, the length of the end of the strip branch away from the thin-film transistor may be extended, such that the end of the strip branch away from the thin-film transistor may be at least partially overlapped with the light-blocking layer 8; and the black domain area may be configured below the light-blocking layer 8, which may reduce the black domain in the opening area, improve the transmittance of the opening area, solve the black domain problem generated at the edge of the pixel electrode 1, increase the transmittance of the light source, and further improve the transmittance of the pixel electrode 1.

The present disclosure provides a display device including the display panel 200 as described above.

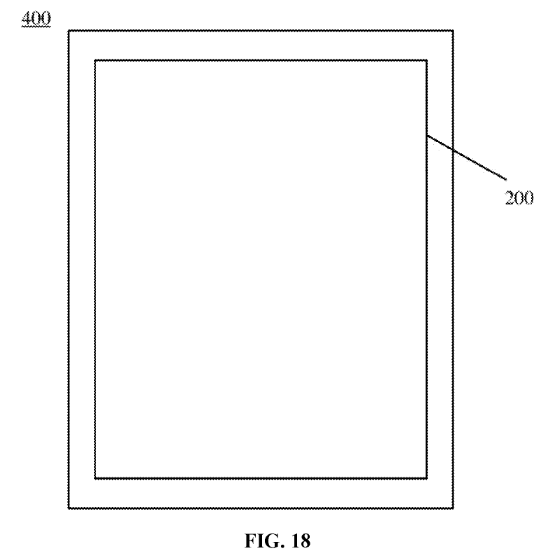

Referring to FIG. 18, FIG. 18 illustrates a structural schematic of a display device according to various embodiments of the present disclosure. The display device 400 provided in FIG. 18 may include the display panel 200. The display panel may be the display panel 200 provided by any of above-mentioned embodiments of the present disclosure. It may be understood that the display device provided by embodiments of the present disclosure may be a display device with a display function such as a computer, a mobile phone, a car display device, a television and the like, which may not be limited in the present disclosure. The display device provided by the present disclosure may have the beneficial effects of the display panel provided by embodiments of the present disclosure, which may refer to the description of the display panel in above-mentioned embodiments and may not be described in detail herein.

It may be seen from above-mentioned embodiments that the present disclosure may at least achieve the following beneficial effects.

The display panel provided by the present disclosure includes a substrate; a touch-control wiring, where the touch-control wiring is electrically connected to a common electrode through a bridge, and the bridge includes a bridge hole and a bridge wiring; and a plurality of data lines and a plurality of scan lines. The plurality of data lines and the plurality of scan lines are cross-arranged to form a plurality of pixel units arranged in an array; a pixel unit of the plurality of pixel units includes a thin-film transistor and a pixel electrode; an end of the pixel electrode away from the thin-film transistor is a first end, and an end of the pixel electrode adjacent to the thin-film transistor is a second end; the thin-film transistor includes a drain electrode; the drain electrode is electrically connected to the pixel electrode through a drain-electrode hole; the pixel electrode includes a plurality of strip branches; the plurality of strip branches include a first-type strip branch and a second-type strip branch; the first-type strip branch is adjacent to the bridge hole and/or the drain-electrode hole; and at the first end, a length of a projection of the first-type strip branch on the substrate along a first direction is less than a length of a projection of the second-type strip branch on the substrate along the first direction, where the first direction is an extension direction of the plurality of strip branches. By optimizing the pixel design, the length of the first-type strip branch adjacent to the bridge hole and/or the drain-electrode hole may be reduced while ensuring the high transmittance of the pixel electrode, thereby avoiding the short circuit between the pixel electrode and the bridge wiring at the bridge hole due to extremely small spacing, and also avoiding the short circuit between the pixel electrode and the pixel electrode at adjacent drain-electrode hole due to extremely small spacing.

The above may be merely embodiments of the present disclosure, which may make those skilled in the art to understand or implement the present disclosure. Various modifications to embodiments of the present disclosure may be apparent to those skilled in the art. General principles defined in the present disclosure may be implemented in other embodiments without departing from the spirit or scope of the present disclosure. Therefore, the present disclosure may not be limited to embodiments described in the present disclosure but may be accorded the widest scope consistent with the principles and novel features of the present disclosure.

What is claimed is:

1. A display panel, comprising:
a substrate;
a touch-control wiring, wherein the touch-control wiring is electrically connected to a common electrode through a bridge, and the bridge includes a bridge hole and a bridge wiring; and
a plurality of data lines and a plurality of scan lines, wherein the plurality of data lines and the plurality of scan lines are cross-arranged to form a plurality of pixel units arranged in an array; a pixel unit of the plurality of pixel units includes a thin-film transistor and a pixel electrode; an end of the pixel electrode away from the thin-film transistor is a first end, and an end of the pixel electrode adjacent to the thin-film transistor is a second end; the thin-film transistor includes a drain electrode; the drain electrode is electrically connected to the pixel electrode through a drain-electrode hole; the pixel electrode includes a plurality of strip branches; the plurality of strip branches include a first-type strip branch and a second-type strip branch; the first-type strip branch is adjacent to the bridge hole and/or the drain-electrode hole; and at the first end, a length of a projection of the first-type strip branch on the substrate along a first direction is less than a length of a projection of the second-type strip branch on the substrate along the first direction, wherein the first direction is an extension direction of the plurality of strip branches.

2. The display panel according to claim 1, wherein:
a distance between the first-type strip branch and the bridge hole and/or a distance between the first-type strip branch and the drain-electrode hole is ≤ 2.6μm.

3. The display panel according to claim 1, wherein:
the first-type strip branch includes a first bent portion and a second bent portion; the first bent portion intersects the second bent portion; and an intersection of the first bent portion and the second bent portion is a first corner.

4. The display panel according to claim 3, wherein:
the second-type strip branch includes a third bent portion and a fourth bent portion; the third bent portion intersects the fourth bent portion; an intersection of the third bent portion and the fourth bent portion is a second corner; and an angle of the second corner is greater than an angle of the first corner.

5. The display panel according to claim 1, further including:
a light-blocking layer, wherein along a direction perpendicular to the display panel, the second-type strip branch is at least partially overlapped with the light-blocking layer.

6. The display panel according to claim 5, wherein:
along the direction perpendicular to the display panel, the first-type strip branch is at least partially overlapped with the light-blocking layer.

7. The display panel according to claim 1, wherein:
in two adjacent rows and/or two adjacent columns of a plurality of pixel electrodes, along the first direction, a tilting direction of a pixel electrode is opposite to a tilting direction of another pixel electrode in an adjacent row and a same column; or along the first direction, a tilting direction of a pixel electrode is opposite to a tilting direction of another pixel electrode in an adjacent column and a same row; or along the first direction, a tilting direction of a pixel electrode is opposite to a tilting direction of another pixel electrode in an adjacent row, and opposite to a tilting direction of another pixel electrode in an adjacent column.

8. The display panel according to claim 1, wherein:
in the pixel unit, the thin-film transistor is at a side or a middle position of the second end of the pixel electrode along a second direction, wherein the first direction is perpendicular to the second direction.

9. The display panel according to claim 1, wherein:
a projection of a part of the plurality of strip branches of the pixel electrode on the substrate along the second direction is overlapped with a projection of the thin-film transistor on the substrate along the second direction.

10. The display panel according to claim 9, wherein:
at least a part of the plurality of strip branches includes a first wiring and a second wiring; the first wiring and the second wiring have an intersection; and a projection of the intersection on the substrate along a second direction is overlapped with a projection of the thin-film transistor on the substrate along the second direction, wherein the first direction is perpendicular to the second direction.

11. The display panel according to claim 1, wherein:
the bridge hole is any one of a vertical hole, an oblique hole, and a horizontal hole.

12. The display panel according to claim 11, wherein:
a length of a projection of a first-type strip branch, which is adjacent to the bridge hole, on the substrate along the first direction is less than a length of a projection of a first-type strip branch, which is away from the bridge hole, on the substrate along the first direction.

13. The display panel according to claim 3, wherein:
an angle of a first corner adjacent to a bridge hole, which is close to the first end of the pixel electrode, is less than an angle of a first corner away from a bridge hole, which is close to the first end of the pixel electrode.

14. The display panel according to claim 11, further including:
a light-blocking layer, wherein projections of the vertical hole and the light-blocking layer on the substrate are overlapped with each other; and a projection of two opposite end portions, which are of the first-type strip branch along the first direction, on the substrate along the second direction is not overlapped with a projection of two opposite end portions, which are of the second-type strip branch along the first direction, on the substrate along the second direction.

15. The display panel according to claim 1, wherein:
the pixel electrode includes a connecting portion; and ends of the plurality of strip branches adjacent to the thin-film transistor are connected to each other through the connecting portion.

16. The display panel according to claim 15, further including:
a light-blocking layer, wherein ends of the plurality of strip branches away from the thin-film transistor are all not connected to each other through the connecting portion; and along a direction perpendicular to the display panel, the ends of the plurality of strip branches away from the thin-film transistor are at least partially overlapped with the light-blocking layer.

17. A display device, comprising:
a display panel, comprising:
a substrate;
a touch-control wiring, wherein the touch-control wiring is electrically connected to a common electrode through a bridge, and the bridge includes a bridge hole and a bridge wiring; and
a plurality of data lines and a plurality of scan lines, wherein the plurality of data lines and the plurality of scan lines are cross-arranged to form a plurality of pixel units arranged in an array; a pixel unit of the plurality of pixel units includes a thin-film transistor and a pixel electrode; an end of the pixel electrode away from the thin-film transistor is a first end, and an end of the pixel electrode adjacent to the thin-film transistor is a second end; the thin-film transistor includes a drain electrode; the drain electrode is electrically connected to the pixel electrode through a drain-electrode hole; the pixel electrode includes a plurality of strip branches; the plurality of strip branches include a first-type strip branch and a second-type strip branch; the first-type strip branch is adjacent to the bridge hole and/or the drain-electrode hole; and at the first end, a length of a projection of the first-type strip branch on the substrate along a first direction is less than a length of a projection of the second-type strip branch on the substrate along the first direction, wherein the first direction is an extension direction of the plurality of strip branches.
